(19) United States
(12) Patent Application Publication
(10) Pub. No.: US 2023/0263362 A1
(43) Pub. Date: Aug. 24, 2023

(54) WASHING APPLIANCE WITH WATER SOFTENER

(71) Applicant: Fisher & Paykel Appliances Limited, East Tamaki, Auckland (NZ)

(72) Inventors: Aaron Ignatius Wei Liang Yong, Dunedin (NZ); Ellen Louise Palmer, Christchurch (NZ)

(21) Appl. No.: 18/012,565

(22) PCT Filed: Jul. 16, 2021
(86) PCT No.: PCT/NZ2021/050109

§ 371 Date: Dec. 22, 2022

(30) Foreign Application Priority Data
Jul. 16, 2020 (NZ) 766285

(51) Int. Cl. A47L 15/42; C02F 1/42

(52) U.S. Cl. CPC A47L 15/4231; C02F 1/42; C02F 2307/12

(57) ABSTRACT

A washing appliance such as a dishwasher or laundry washing machine comprises an ion-exchange water softening section and a brine generator to supply brine to the water softening section to regenerate ion-exchange resins therein, and a valve (such as a float valve) in a water supply conduit to the brine generator. The valve permits water to flow into the brine generator but blocks back-flow of liquid from the brine generator to the water supply conduit.

### TECHNICAL FIELD

The invention relates to washing appliances such as dishwashers or textile or laundry washers, comprising a water softener with a brine generator.

### BACKGROUND ART

A washing appliance such as a dishwasher or a laundry washer can comprise an integral water softener to soften mains water entering the appliance. In the water softener, ion-exchange resins typically in the form of small resin beads, exchange calcium ions (Ca²⁺) and magnesium ions (Mg²⁺) in hard water, with sodium ions (Na⁺) to “soften” the water entering the appliance. The water softener also comprises a brine generator in which salt (NaCl) is dissolved in water, to supply brine to regenerate the ion-exchange resins which become exhausted as their Na⁺ ions are consumed (substituted by Ca²⁺/Mg²⁺ ions). Salt in the brine generator is replenished periodically by the user.

Our earlier U.S. Pat. No. 7,988,790B2 discloses a washing appliance comprising a water softener using ion-exchange resins and a brine generator to which solid salt is occasionally added. In the embodiments discussed in that document in relation to FIGS. 5 and 6 thereof, a level of liquid in the brine generator can be controlled by a float valve on a brine tank water refill path from a fresh water supply, so that the level of liquid in the brine generator does not fall below a predetermined level, to ensure brine is always available. To avoid brine escaping from a salt addition/inlet port during refilling of the brine generator, the float valve is positioned very low in the brine generator so that the predetermined brine level is well below the height of the salt addition port. As a result, the volume of brine able to be generated is relatively low in comparison to the size of the brine generator. Also, under some fault conditions, there is potential for the liquid level in the brine generator to rise above the level of the float valve inlet, so that any failure/leakage of the float valve seal could result in brine back-flowing into the brine tank refill path.

In some appliance water softening systems, for example in some dishwashing appliances sold under our DISHDRAWER trade mark, the brine generator water refill path also doubles as the brine overflow path from the brine generator. This common liquid path is therefore “two way” and is always open. To avoid the need for additional wiring, sensors and/or a diverter valve, the brine generator filling arrangement may bleed-off water passively from a pressurised water supply such that it flows, via gravity (that is, under a low pressure), to the brine generator. Incoming fresh water from the supply is diverted or bled-off (such as during water filling of the appliance) into the common liquid path so that the salt water level in a brine container of the brine generator is maintained at a desired level. Once the brine container reaches a “full” level, the bled-off brine generator-filling liquid flow overflows to an outlet in the appliance's tub (wash chamber).

The same, common path can also be used to transport overflowing brine in the opposite direction, from the brine generator to the overflow outlet within the tub. In this way, under normal operating conditions, the brine level within the brine generator is unable to nominally exceed a maximum level, which is arranged to be well below the level of a salt refilling opening of the brine generator. Because of this arrangement, when a user is refilling the brine generator with solid granular salt from a container, brine does not overflow onto the user's hands or into the salt container. This arrangement is described in our aforementioned U.S. Pat. No. 7,988,790B2 (see FIGS. 4 and 4A thereof).

In the above-described water softening system, the common liquid path will always be filled with either brine or fresh water. As the brine generator water refill path is provided with fresh water whenever the tub is filling, unless brine has just been extracted from the brine generator to regenerate the ion-exchange resin, the brine level in the brine generator will usually be at its nominal “full” level. Even when the common path has recently been filled with fresh water, when the brine generator is full, the liquid in the common path will be in fluid communication with the store of brine and so salt in the brine solution can migrate into the fresh water in the common flow path. Thus, liquid flowing from the overflow into the tub will usually contain some dissolved salt.

Over time, following salt-containing liquid exiting the overflow outlet into the tub, unsightly salt crystals will form on tub surfaces that were contacted by or temporarily held, the overflowing liquid. If a washing or rinsing cycle of the appliance is carried out within a short period of time following salty liquid overflowing into the tub, salt crystallisation will be avoided. However, if salt water overflow occurs at the end of a washing cycle of the appliance, when it may be some hours or days until the tub's surfaces will next be washed, salt crystallisation will occur. Because the water softener is mounted in a movable drawer of a DISHDRAWER™ dishwasher, and because the brine level is nearly always full, opening of a drawer following a washing cycle, to access the clean dish load held therein, can cause salt water to spill from the overflow into the tub. Also, as mentioned above, when the brine generator reaches its full level, any additional fresh water flow into the common liquid path will overflow to the tub, taking some salt water with it.

It is an object of the invention to provide a washing appliance with an improved or at least alternative ion-exchange water softener with a brine generator which will go at least some way to ward overcoming at least some of the above problems or which will at least provide the public with a useful choice.

### SUMMARY OF INVENTION

In broad terms the invention comprises a washing appliance comprising:
a water softener containing ion-exchange resin,
a brine generator to supply brine to the water softener for regenerating the ion-exchange resin therein, the brine generator having a brine container with a filling orifice to allow solid salt to be added to the brine container,
a water supply path for providing water, via an entrance port, to the brine container, and
a valve that opens the entrance port when the liquid in the brine container is at a relatively low level and closes the entrance port when liquid in the brine container is at a relatively high level, the valve preventing backflow of liquid from the brine container to or through the water supply path when the liquid is above the level of the entrance port so that brine displaced by solid salt added to the brine container is able to flow out of the brine container via the filling orifice in preference to the water supply path.

The washing appliance can be a dishwasher or a laundry washing machine.

In a washing appliance according to preferred forms of the invention, salt crystallisation cannot occur around the overflow hole of the wash chamber because any liquid flowing from the overflow hole will not contain salt. Salt water could, however, flow from the salt-refilling orifice of the brine container during refilling. But it is most likely that a user will initiate a washing or rinsing cycle soon after refilling the brine container and so any salt that spills into the tub during refilling will quickly be washed away.

In this specification “comprising” means “consisting at least in part of”. When interpreting a statement in this specification and claims that includes “comprising”, features other than that or those prefaced by the term may also be present. Related terms such as “comprise” and “comprises” are to be interpreted similarly.

### BRIEF DESCRIPTION OF DRAWINGS

The invention is further described with reference to the accompanying drawings by way of example, in which:

FIG. 1 is a diagrammatic cross-sectional side elevation of a drawer-type dishwasher,

FIG. 2 is a diagrammatic/schematic view of a water softener from FIG. 4 of our prior U.S. Pat. No. 7,988,790B2,

FIG. 3 is a diagrammatic/schematic view of another water softener from FIG. 4A of our prior U.S. Pat. No. 7,988,790B2,

FIG. 4 is a view similar to FIGS. 2 and 3 but of a water softener according to an embodiment of the invention, showing a float valve controlling water supply to the brine generator with the float valve closed,

FIG. 5 is a view similar to FIG. 4, of the water softener of an embodiment of the invention, showing the float valve controlling water supply to the brine generator with the float valve open,

FIG. 6 shows the water softener of FIGS. 4 and 5 during salt addition to the brine generator,

FIG. 7 is a view similar to FIG. 4 but of a water softener according to a further embodiment of the invention showing a float valve controlling water supply to the brine generator with the float valve closed,

FIG. 8 is a view similar to FIG. 5 but of the further embodiment shown in FIG. 7 showing the float valve controlling water supply to the brine generator with the float valve open, and

FIG. 9 is a view similar to FIG. 6 but of the further embodiment of FIGS. 7 and 8 showing the water softener during salt addition to the brine generator.

### DESCRIPTION OF EMBODIMENTS

### Dishwasher Overview

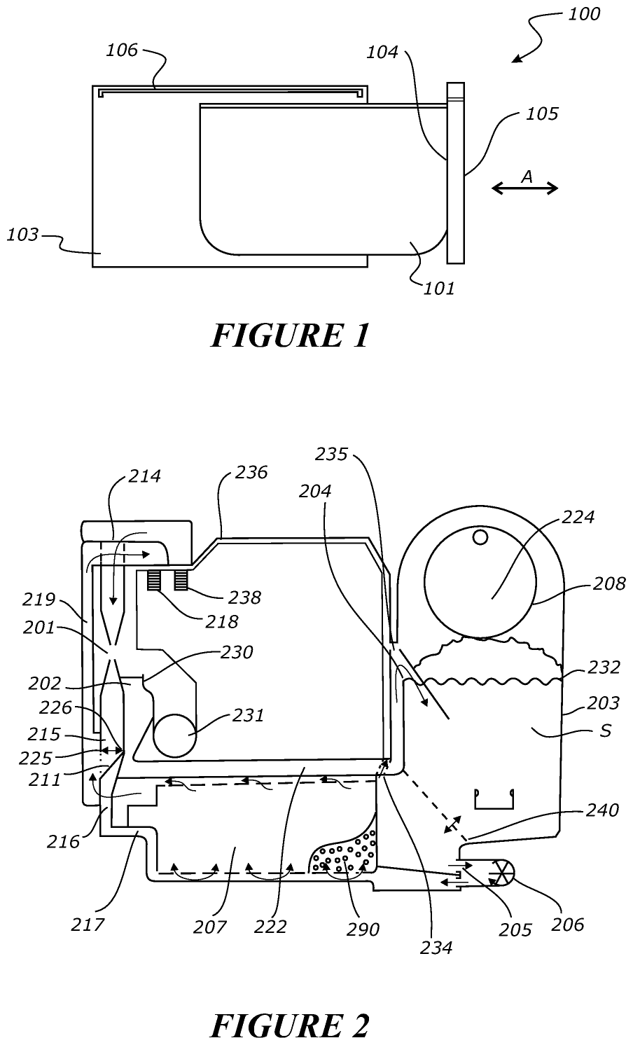

FIG. 1 is a diagrammatic cross-sectional side elevation view of an exemplary dishwasher 100 of the drawer-type or drawer-style such as our DISHDRAWER™ dishwasher (see, for example, our prior patent publications WO9312706A and WO9833426A, the entire contents of which are incorporated by reference herein). A single-drawer dishwasher is shown, with the wash drawer 101 partly open, although double-drawer versions of the dishwasher, with two vertically arranged drawers within a single cabinet are available.

As is known, the or each wash drawer 101 is slidably mounted within an outer cabinet 103 in a drawer-style arrangement, and the wash drawer 101 comprises an internal front wall 104 behind a front panel 105, left and right side walls (not shown), an end wall, and a base, which together define a wash chamber or wash space (or tub) within the wash drawer 101, having an open top. In use, the wash drawer 101 is withdrawn from the external cabinet 103 for loading and unloading dishes and/or cutlery, and when loaded or empty is pushed home into the cabinet 103 to close the drawer 101, and enable washing to occur when loaded (see arrow A in FIG. 1 indicating wash drawer movement). When the wash drawer 101 is home in the cabinet 103 the open top of the wash drawer 101 is closed by an internal lid 106 that is movable vertically within cabinet 103.

Each wash drawer 101 comprises an associated wash system including a main wash water inlet valve, wash pump, rotating spray arm for directing wash liquid such as a water and detergent mixture onto items in the wash chamber, drain pump, heater, wash water filtration system, and a controller. The wash system is provided on or in the drawer and water (both supply and waste) connections to the wash drawer are adapted to cope with movement of the drawer in and out of cabinet 103. Washing cycles are initiated via a user interface panel that may be provided on front panel 105.

The wash system of dishwasher 100 can also comprise an integral water softener, also referred to herein as a water softening section. In the drawer-type dishwasher shown, the water softening section includes a brine generator and can be located in a space between the internal front wall 104 and the front panel 105. A port (208, FIG. 2) with a closure cap, bung or similar, enables the user to add salt to the brine generator. In other embodiments a water softening section can be positioned in any other location in the dishwasher. A drawer-type dishwasher is referred to by way of example only, and a dishwasher incorporating water softener or water softening section according to an embodiment of the invention may equally be of the more common type comprising a front drop-door pivotally mounted about its lower edge for example, or of any other type.

### Prior Art Water Softening Section

FIG. 2 is a diagrammatic/schematic view of a water softener of U.S. Pat. No. 7,988,790B2 (the entire content of which is incorporated by reference herein). The water softener is designed to be located, for example, in the hollow space between internal front wall 104 and front panel 105 of a drawer of a drawer-type dishwasher as in FIG. 1. In the flow path of water through the appliance, the water softener is located between the main water inlet valve and the wash drawer 101. FIG. 2 shows the water softener viewed in a direction looking through the internal front wall 104 from the interior of the wash drawer 101.

The water softener includes a resin container 207 which contains ion-exchange resin beads. Water supplied to the dishwasher to be softened passes through the resin container 207. Brine, for occasionally regenerating the ion-exchange resin, is developed in a brine container 203, which contains salt S and to which water is diverted or leaks from the primary or main water supply (from the appliance water inlet valve) at an air break 201. In the regenerating cycle brine is delivered from the brine container 203 to the resin container 207 by a brine pump 206.

In a normal washing cycle, water enters from the main flow control valve, through inlet 238 and supply conduit 214. The supply conduit 214 leads to air break 201 which is provided to prevent backflow of liquid to the supply. The incoming flow passes through the air break 201 to a flow control valve 211 via conduit 215. The flow control valve 211 is controlled by the appliance controller and determines whether or not the water entering the wash chamber is softened by the ion-exchange resin in container 207, or whether it bypasses the resin container 207 and therefore is not softened. The water flow then enters the wash chamber, preferably via a detergent dispenser (not shown but, for example, as shown and described in the aforementioned WO9833426A and located within the central open space of the water softener) that is preferably also mounted within the front wall of the wash drawer 101 and which is provided with detergent by a user. When the supply water is to be softened the flow control valve 211 is in position 225 and water flows through the flow control valve 211 and via conduit 217 to resin container 207. The water is softened by passing through a matrix 290 of ion-exchange resin beads in the resin container 207, and then eventually enters the wash chamber via conduit 219, outlet 218 and the detergent dispenser.

When the supply water is not to be softened, the flow control valve 211 is in position 226 so that the water softening section is bypassed by the supply water flow, and supply water flows directly to the wash chamber via conduit 219, outlet 218 and the detergent dispenser.

Optionally, the dishwasher controller may, also via the flow control valve 211, divert some but not all supply water through the water softening section, to mix non-softened water and softened water to achieve the desired softness level of water supplied to the wash chamber. This can reduce the hardness of the supply water but can also be used to avoid over-softening of the water. Mixing could be achieved by moving valve 211 to a position that directs a desired proportion of the supply water through the water softening section at the same time as the remainder of the supply water is directed to outlet 218. Alternatively, or in addition, this could be achieved by moving the flow control valve in a temporal pattern, according to a selected duty cycle, between first and second consecutive positions including a first position that only directs supply water through the water softening section and a second position that only directs the supply water to outlet 218. Some cycles in the washing program may not require soft water, for example the initial rinse, and the controller can therefore switch the flow control valve 211 to achieve the desired water softness for each cycle.

Regeneration by Brine

Brine is produced in a brine container 203 by dissolving salt S in water. Brine is supplied to the resin container 207 to regenerate the ion-exchange resin as Na⁺ ions are consumed in the water softening process.

To supply water to the brine container 203, a small proportion of the pressurised supply water to the dishwasher is bled-off, leaks or is diverted at or near air break 201 via path 202 that feeds water supply conduit 222. Thus, water supply conduit 222 is provided with a supply of water whenever the dishwasher is receiving its primary (selectively softened) supply of water to the tub. The leakage to path 202 flows under gravity via conduit 222 into the brine container 203 at a weir 204. Any excess liquid in the brine container 203 overflows weir 204 and flows back along the water supply conduit 222, overflowing a weir 230 before entering the wash chamber via an overflow port 231. The overflow port 231 may be provided in a lower region of the inside surface of the front wall 104 of the wash chamber/wash drawer 101.

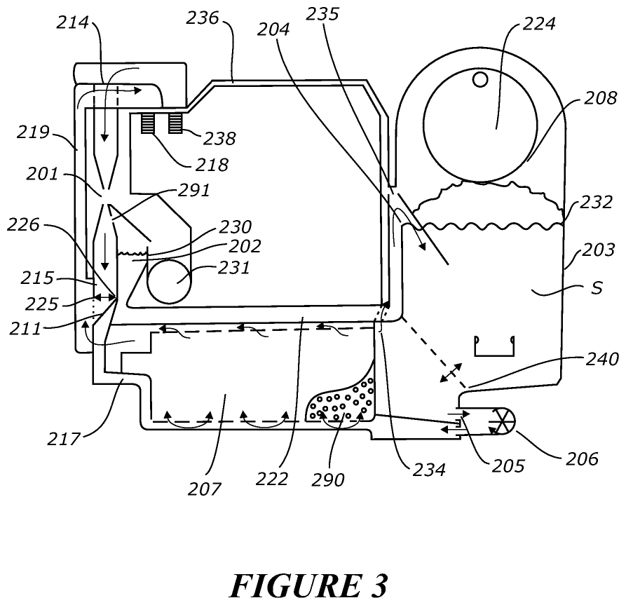

FIG. 3 is a diagrammatic/schematic view of a water softening section also of prior patent U.S. Pat. No. 7988790B2 and similar to that of FIG. 2 (and the same reference numerals indicate the same parts), but in which as an alternative a small hole 291 in conduit 215 provides for the bleeding off of a small proportion of water from the main supply that flows under gravity to the brine generator. Excess leakage from hole 291 overflows weir 230 and flows to the overflow port 231 and into the wash chamber.

In both the embodiments of FIGS. 2 and 3 a salt addition port 208 is provided for the user to, as required, add new solid granular salt into the brine container 203. For example, the controller may monitor the level of salt in the brine container and alert the user to add solid granular salt when necessary. The salt addition port 208 opens through the internal front wall 104 of the dishwasher and is closed with a cap or bung 224 when not being used for salt addition. Cap or bung 224 may incorporate one or more opening to enable air to enter/exit the brine container as the brine level changes so that atmospheric pressure within the container can be maintained.

In normal operation the liquid (that is, brine when salt is present) in the brine container 203 is at a relatively high or maximum level as indicated at 232 in FIGS. 2 and 3. When the dishwasher is not carrying out a washing/rinsing cycle and new salt is being added through the salt addition port 208 into the brine container 203, 25 the level of liquid in the brine container is maintained at level 232. This is because liquid displaced by the volume of the added salt overflows the weir 204, and flows back towards the overflow port 231 in the wash chamber, as described previously. Air vents 234, 235 also allow for air escape from brine container 203 via conduit 236.

It is beneficial to maximise the volume of brine that may be held in the brine container 203. In FIGS. 2 and 3, the maximum brine level is set by the height of weir 230, because any higher brine level overflows weir 230 to port 231. In some production versions of our DISHDRAWER™ dishwasher, weir 230 is positioned at a higher level than weir 204 at the brine container so that the “full” level of brine container is above the level of weir 204. This also creates a pressure head that causes water to flow preferentially into the brine container rather than directly to overflow port 231.

An outlet 205 from the brine container 203 feeds brine to the brine pump 206 which, when operated by the dishwasher controller, pumps brine through resin container 207 replenishing ion-exchange resins 290. Filtering mesh 240 prevents solid salt from being pumped through the resin container 207. Excess liquid pumped through the resin container 207, containing exchanged calcium and magnesium ions, is drained away via conduit 219 and outlet 218 to the dishwasher wash chamber, at an appropriate part of the wash cycle, from where it can be pumped to the drain. The brine pump 206 is controlled by the dishwasher controller and the quantity/rate of brine delivery to the resin container 207, and thus degree of regeneration, can be controlled by controlling the brine pump 206.

### Water Softener of Invention

With a water softening section as described above, salt crystallisation can occur around the overflow port 231 in the wash chamber. This is because when a user adds salt to the brine generator, liquid that contains dissolved salt can be displaced over weir 204 and back along the water supply conduit 222 to the overflow port 231 which is always exposed to the wash chamber. Also, when the water supply conduit 222 is initially filled with fresh water which is in contact with brine in the brine container 203, salt in the brine migrates into the fresh water within the conduit turning it to brine.

When conduit 222 is full (and therefore inevitably contains brine), further water bleeding or leaking into path 202, or even opening of the wash drawer by a user, can cause brine to overflow weir 230 of conduit 222 and out overflow port 231. In the former case, it is common for a user to commence a washing/rinsing cycle of the dishwasher following the addition of salt and so the overflowed brine is diluted and eventually washed into the drain. In the latter case, this brine, or a residual amount of it which does not exit to the drain via the overflow port 231, may pool in the bottom of the wash chamber/wash drawer or on other internal surfaces of the wash chamber, around the overflow port 231. Subsequently, if the dishwasher is not used for some time, the water in this pooled liquid can evaporate, depositing salt crystals around the overflow port 231 and in the bottom of the wash drawer near the overflow port. This salt formation in the wash chamber is unsightly and this problem is avoided with the water softener including brine generator according to embodiments of the invention.

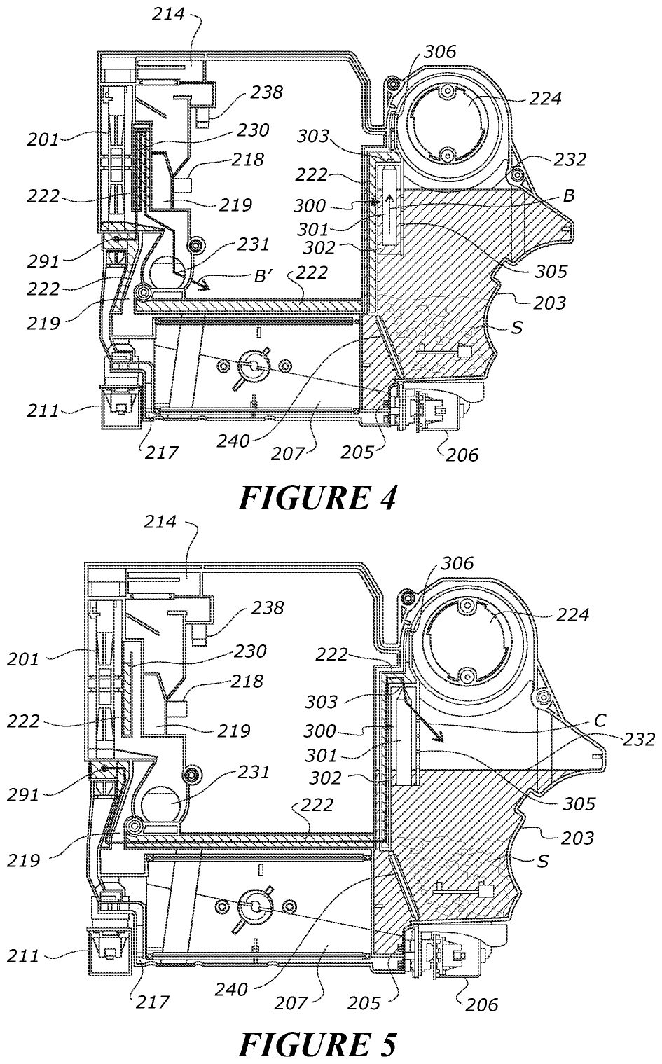

FIGS. 4 to 6 show a water softener according to an embodiment of the present invention. The water softener is similar to that of FIGS. 2 and 3 and unless indicated otherwise the same reference numerals indicate the same parts, and the general operation of the water softener is the same or similar. However in the water softener of the embodiment of the invention a one-way float valve is provided in the water supply path to the brine generator. The float valve prevents brine from being displaced or leaking into the wash chamber. As explained above, this is particularly advantageous when the displacement or leakage of brine into the wash chamber would not have been followed by a wash/rinse cycle that would have diluted/removed the brine on/from surfaces of the wash chamber.

In particular in relation to the embodiment shown in FIGS. 4 to 6, a float valve generally indicated at 300 is provided, which allows water from air break bleed hole 291 to flow to the brine generator via conduit 222. The float valve also prevents backflow in the opposite direction, so that brine is blocked from entering water supply conduit 222 and therefore cannot flow out of overflow port 231 into the wash chamber.

The float valve 300 comprises a small float 301 housed in a float chamber 302 which is in line in the water supply path to the brine generator, from air break bleed hole 291. Float 301 is movable, at least vertically, within float chamber 302. There is a water entry port to the float chamber 302 at 303, which comprises a valve seat engaged by a valve member on the float when the valve is closed — see in particular FIG. 4. In the embodiment shown, the float valve 301 is an in-line float valve. That is, the float chamber 302 and float 301 are in-line with the water supply conduit 222, and the water entry port 303 is at one end of the float chamber 302. The float chamber 302 and float 301 have common longitudinal axes, which are in turn in line with or concentric with the direction of water flow through the float valve when the valve is open. Ideally, the common longitudinal axes are completely or substantially vertically-aligned.

The float chamber 302 is open to or in fluid communication with the interior of the brine container 203, so that the float chamber 302 is filled with brine liquid to the same level as the brine container 203. In the embodiment shown, plural apertures 305 in a side wall of the float chamber 302 communicate to the interior of the brine container 203. Apertures 305 are shaped and/or positioned to restrict/prevent solid salt granules from entering float chamber 302 while allowing brine or water to pass freely between the float chamber 302 and brine container 203. For example, apertures 305 may be conical or cylindrical or “slit”-shaped. Ideally the horizontal width of the float chamber is only slightly larger than the horizontal width of the float so that the valve member on the float maintains alignment with the valve seat by constraining float 301 to vertical movement only by contact between the side wall(s) of the float and the inner side wall(s) of the float chamber. For example, the float may be cylindrical in shape and the float chamber may also be cylindrical in shape. Thus the float 301 rises and falls within its float chamber 302 with changes in the liquid level in the brine container 203, as indicated by arrow B in FIG. 4.

When the liquid level 232 in the brine container 203 is relatively high, or at its nominal maximum or “full” level, the valve member at the top of float 301 engages the valve seat of water entry port 303 to the float chamber, which prevents inflow of water from the supply conduit 222 to the brine container 203. The float 301 is shown in this closed position in FIG. 4 with water level 232 in the brine container at the nominal maximum or“full” level. The nominal full level is arranged to provide a sufficiently high volume of brine in the brine container to effectively regenerate the ion-exchange resin beads in resin container 207 while reducing the likelihood that brine will reach slop out of venting holes in cap or bung 224 if the drawer experiences a sudden movement. When the float valve 300 is closed, but the water softener is softening or bypassing water from the main supply, bled-off fresh water from hole 291 will eventually fill conduit 222 until it overflows weir 230 and passes into the wash chamber via overflow port 231—as indicated by arrow B′.

The water supply conduit 222, at its brine container end, extends vertically above water entry port 303, and above the lowest level of salt addition port 208, and above weir 230, to a small opening 306 around salt addition port 208. Opening 306 ensures that air trapped in conduit 222 can escape the conduit and exit the water softener via an air gap in or around bung 224 during filling of conduit 222. In this way, an air-lock in the water supply path to the brine container is avoided and a supply of water will therefore be present at entry port 303 as soon as float valve 300 is opened. Because opening 306 is above the height of weir 230, water in conduit 222 will not ordinarily reach the level of opening 306, even when float valve 300 is closed.

When the liquid level in the brine container 203 is lower than the nominal “full” level, the float 301 falls within the float chamber 302, opening the water entry port 303. Because weir 230 is above the height of water entry port 303, the pressure head created allowing gravitational (that is, low pressure) inflow of water from the supply conduit 222 into the float chamber 302, and through apertures 305 in the side wall of the float chamber to the brine container 203—as indicated by arrow C. The pressure head is arranged to ensure a sufficiently high flow rate of water to the brine container to avoid the container running out of water, raising the liquid level in the brine generator — this is shown in FIG. 5. It will be appreciated that providing a high or mains pressure water supply directly to conduit 222 would detrimentally likely cause float valve 300 to open independent of the level of liquid in brine container 203. While water is being supplied through inlet 238 (and therefore bled-off via hole 291), this liquid level increase continues until the liquid in the brine container 203 and float chamber 302 reaches the high or nominal maximum level at which the valve member on float 301 re-engages the valve seat of the water entry port 303, closing the water entry port and terminating the flow of water into the brine generator. That is, the float returns to the position shown in FIG. 4.

Water supply conduit 222 could broadly be described as substantially “U”-shaped with a central substantially horizontal duct connecting lower ends of substantially parallel, substantially vertical side ducts. Water entry port 303 to the brine container is provided at or near an upper end of a first side duct of the water supply conduit and weir 230 is provided at or near an upper end of a second side duct. The upper end of the second side duct, at or near weir 230, is connected to overflow port 231 by an overflow passage. The second side duct of water supply conduit 222 is fed with a supply of water from bleed hole 291 at a position between its upper and lower ends, for example about mid-way between its upper and lower ends. It will be appreciated from FIGS. 4 to 6 that a horizontally-extending portion of the overflow passage connecting air-break 201 and weir 230 to overflow port 231 crosses in front of the second side duct of conduit 222.

It will be appreciated that the nominal or “full” level of the brine container 203, as controlled by float valve 300, is below the height of water entry port 303 but well above the lowest height of water supply conduit 222 so that the volume of brine available in the brine container is considerable and maximised. As mentioned earlier, for the brine container to be gravity-fed (rather than via mains pressure), this requires that weir 230 be even higher to ensure sufficient pressure head so that water preferentially flows in conduit 222 towards the brine container at a sufficiently high flow rate to avoid the container emptying during normal operation. It will also be appreciated that water entry port 303 is at a height that is vertically displaced above the height of the overflow port 231.

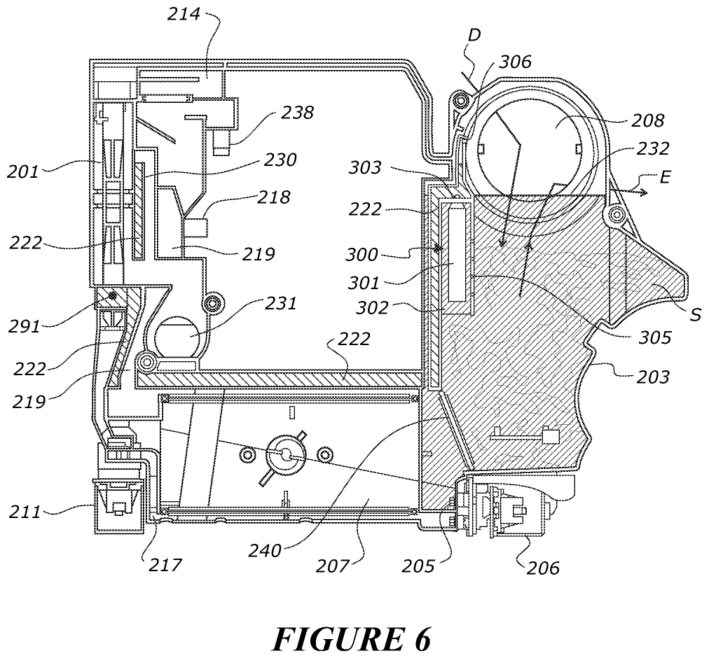

Although the embodiment of the invention illustrated by FIGS. 4 to 6 shows brine container water entry port 303 at or about the same height as the lowest part of salt addition port 208 (see FIG. 6), it will be appreciated that the water entry port could be below, at or above the height of the lowest part of the salt addition port because in any case the float valve will stop brine/salt from flowing/migrating back into water supply conduit 222. Therefore the location of the water entry port 303 (and the float valve in general) can be decided based upon criteria other than relative height levels that will avoid back-flowing, such as efficient space utilisation and maximising brine volume.

### Water Softener of Invention—Salt Addition

FIG. 6 shows the water softener during salt (preferably solid granular salt) addition to the brine generator. New salt addition into the brine container through salt addition port 208—as indicated by arrow D in FIG. 6—causes the level of liquid in the brine container 203 to rise. Should the liquid in the brine container 203 and float chamber 302 reach the nominal full level of the brine container during salt addition, float 301 will close the water entry port 303. This prevents contact between the liquid in the brine container and liquid (that is, fresh water) in conduit 222 as yet more salt is added. It also prevents liquid in the brine container back-flowing through the float valve 300 and entering the water supply conduit 222, to flow to the wash chamber via overflow port 231 as described previously for the prior art embodiments of FIGS. 2 and 3.

Instead, the level of liquid in the brine container 203 rises until it reaches the level of the salt addition port 208 and then overflows directly from the salt addition port into the wash chamber—as indicated by arrow E in FIG. 6. Thus, the invention ensures that no brine is able to come into contact with, or is able to flow into, conduit 222 so that brine cannot flow into the wash chamber via overflow port 231. Because the user can or will usually carry out a wash/rinse cycle of the dishwasher following salt re-filling, the aforementioned salt crystallisation problem is averted.

In order for brine to overflow from salt addition port 208 the brine level will need to rise slightly above the lowest level of the salt addition port. So if the valve seat of water entry port 303 is at the same level as, or even just below, the bottom of the salt addition port then float valve 300 must remain closed during this overflowing from the salt addition port. However, should the float valve fail and allow brine to leak into conduit 222, the arrangement illustrated in FIGS. 4 to 6 minimises the impact of this failure while maximising other beneficial aspects of the brine generator. The impact of such a failure is minimised because the water level in brine container 203 is only able to rise slightly above the level of water entry port 303 thereby minimising the volume of brine that could potentially flow into conduit 222 under valve fault/failure conditions.

Accordingly, given the space constraints of washing appliances, in particular dishwashing appliances, such that the brine container is relatively tall but narrow and a front to back thickness that enables it to fit within the space behind the front panel of the appliance, the illustrated arrangement incorporating float valve 300 in the illustrated position relative to weir 230 and salt addition port 208 still manages to ensure that:
the brine container is gravity-fed with a sufficiently high water flow rate to avoid the tank emptying during normal operation,
the volume of brine able to be stored in brine container 203 is maximised,
the volume of brine immediately available to brine pump 206 is increased by locating the float valve in an upper part of the brine tank, above mesh 240 rather than in the lower region below the mesh, and
the volume of brine that could potentially back-flow into conduit 222 should the seal of float valve 303 fail is minimised.

After salt has been added the salt addition port 208 is closed by the user replacing its cap, and during operation of the dishwasher and water softener, the brine generator will operate as described above with reference to FIGS. 4 and 5.

Thus with a water softening section in accordance with an embodiment of the present invention as described above, salt crystallisation cannot occur in the wash chamber, because liquid in conduit 222 is effectively limited to flowing one way—that is, towards the brine generator. Because brine is prevented from back-flowing through conduit 222, it is unable to flow into the wash chamber, in particular at times when there is no imminent, subsequent wash/rinse cycle that would dilute or wash the brine away.

### Further Embodiment

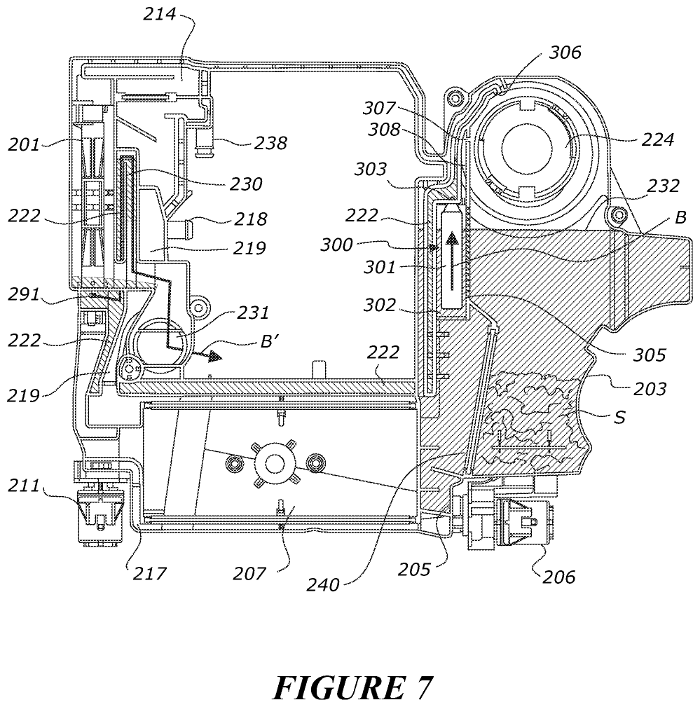

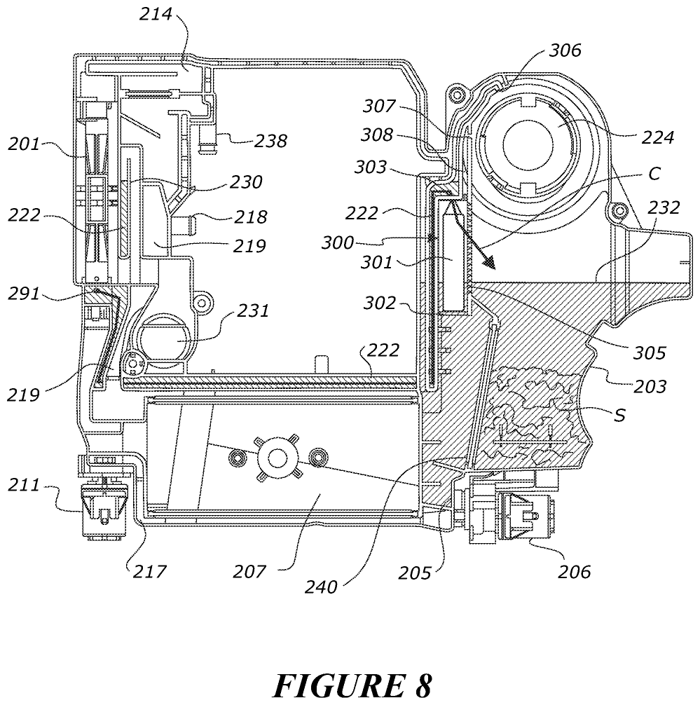

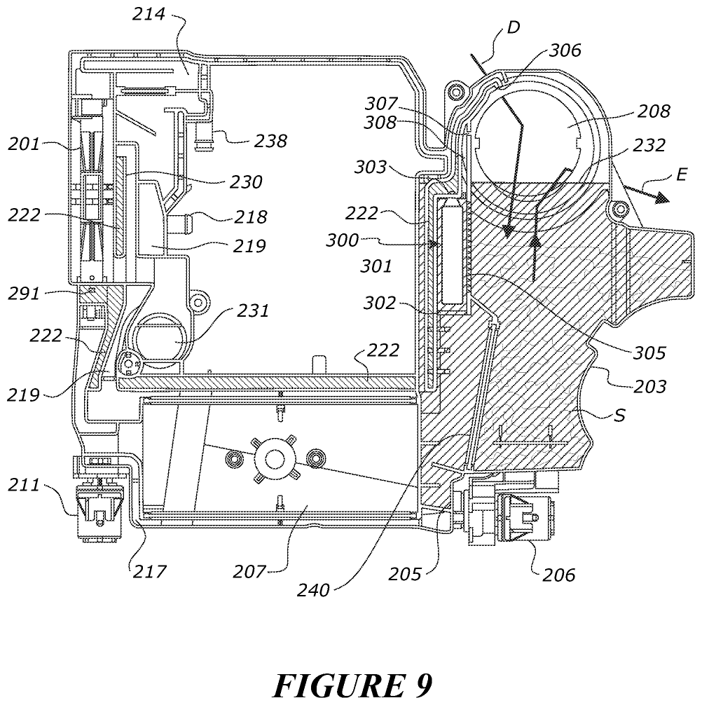

FIGS. 7 to 9 illustrate a further embodiment of water softener according to a preferred form of the present invention which is similar to the embodiment already explained with reference to FIGS. 4 to 6. Accordingly, the reference numerals already used and described in relation to FIGS. 4 to 6 have also been used in FIGS. 7 to 9 to identify the same features, and they provide the same or similar functionality and benefits in this further embodiment. The general construction and functionality of those features that have already been described will therefore not be explained again in relation to the further embodiment.

The construction and layout of the water softener of the further embodiment is very similar to that of the embodiment of FIGS. 4 to 6. The main differences are:
1. Float chamber 302 has been provided with an increased number of apertures 305 so that it is more difficult for salt crystals to completely block all of the apertures. Also, fluid communication between the float chamber and brine container 203 is improved by allowing a greater flow rate of liquid therebetween (i.e., equalisation of liquid levels in the brine chamber and the float chamber will occur more quickly).
2. The position of opening 306 around salt addition port 208 has been raised vertically. Opening 306 ensures that air trapped in conduit 222 can escape the conduit and exit the water softener via an air gap in or around bung 224 during re-filling of conduit 222. By raising opening 306 from its previous position, which was just above the mid-line of salt addition opening 208, to much nearer the level of the highest part of opening 208 (i.e., much higher than the height of weir 230), it is even less likely that liquid will escape from opening 306 into the brine chamber should the water softener or the product be tilted/shaken/disturbed. Equally, increasing the vertical height of opening 306 makes it much less likely that brine from the brine container could escape via opening 306 and enter conduit 222.
3. A new vent aperture 307 is provided at or adjacent to the periphery of salt addition port 208, connected to the float chamber 302 by an air path 308, to allow air trapped in chamber 302 to escape to the atmosphere. Air may become trapped in float chamber 302 when the brine level drops and is unable to escape via apertures 305 in the wall of the float chamber which are vertically lower than the level of the trapped air. Without this escape path for the trapped air, the only alternative escape route for air trapped in the float chamber is via the water entry port 303 when the float valve opens during refilling of the brine chamber. However, when the float valve opens, water immediately enters the float chamber, impeding escaping air. Air trapped within float chamber 302 displaces brine when the brine chamber is full and thereby reduces the buoyancy of the float such that the closing force of the float valve against its seat is reduced, which may enable the float valve to leak.
The vertical height of vent aperture 307 is preferably around the centre level of salt addition port 208, and above the height of the weir 230 so that water/brine will not exit via aperture 307 (for example, should apertures 305 become blocked and the float valve is open). The vertical height of vent aperture 307 is also, generally, above the (maximum) fluid and salt levels in the salt tank (for example, when the brine chamber is filled with salt). Due to this vertical position, brine/fluid will not ordinarily exceed the height of, nor flow in/out of vent aperture 307, but will instead flow through apertures 305 as intended in the design. While it is not essential that fluid flow via vent aperture 307 is avoided, such flow may increase the risk of salt crystallisation in air path 308 resulting in a blockage. A further reason for positioning vent aperture 307 well above the lower edge of the periphery of salt addition port 208 is to avoid or reduce the likelihood that solid salt inadvertently enters air path 308 during refilling of the brine chamber as it may block air path 308 and/or enter the float chamber and interfere with operation of float 301.
As shown in FIGS. 7 to 9, it is preferred that the vertical height of opening 306 is above the vertical height of vent aperture 307, and that both are above the vertical height of weir 230 and/or above the vertical height of the vertically lowest part or level of the opening of salt addition port 208.

### Variations

The invention has been described generally with reference to a drawer-type dishwasher by way of example only, and as referred to previously the dishwasher may instead be of the front drop-door type for example, or the invention may be incorporated within a different type of appliance, such as a laundry washing machine. The water softener and brine generator may be provided in the main door of a front drop door-type dishwasher.

Instead of a float valve 300, most or all of the advantages of the invention could be attained by the use of an alternative one-way valve, such as a check valve. Some alternative valve types may, however, be more susceptible than float valves to leaking and so it may be more difficult to achieve reliable back-flow prevention.

A float valve, as described above, can be considered to be a normally-open valve in that it normally allows flow into the brine container but only floats/seals-off the water supply conduit 222 when the liquid level in the brine container 203 is sufficiently high; that is, when a sufficient portion of the float is submerged. A float valve is therefore inherently able to limit the liquid volume in the brine container as well as ensuring that liquid flow is limited to one direction only. By utilising this behaviour, the liquid level in the brine container can always be limited to be normally lower than the valve seat of the water entry port 303, which makes the system very reliable in preventing backflow (as mentioned above, during salt refilling the water level can of course exceed the nominal full level).

In contrast, a check valve, such as a ball check valve, can be considered to be a normally closed valve in that it is normally closed due to a spring and/or gravity forcing the ball or other closing member against the valve seat, and only opens when the pressure of the incoming liquid in water supply conduit 222 is sufficient to overcome the closing force of the spring/gravity. Due to this behaviour, while the check valve can resist backflow/migration of brine along water supply conduit 222, additional means must be employed to limit the volume of liquid in the brine container because the valve will open whenever sufficient pressure is applied to its inlet side, irrespective of the liquid level in the brine container. Accordingly, additional level or volume control means are required for closing the check valve when a relatively high level of liquid is held in the brine container. Also, the volume of the liquid in the brine container will always end up higher than or above the check valve's seat, if for example weir 230 is used, as some additional pressure is required to open the valve and for water to flow into the brine container. Therefore, the valve seal must be especially reliable to prevent brine backflow/migration into the water supply path 222.

The foregoing describes the invention including preferred forms thereof and alterations and modifications as will be obvious to one skilled in the art are intended to be incorporated within the scope hereof.

1. A washing appliance comprising:
a water softener containing ion-exchange resin,
a brine generator to supply brine to the water softener for regenerating the ion-exchange resin therein, the brine generator having a brine container with a filling orifice to allow solid salt to he added to the brine container,
a water supply path for providing water, via an entrance port, to the brine container, and
a valve that opens the entrance port when the liquid in the brine container is at a relatively low level and closes the entrance port when liquid in the brine container is at a relatively high level, the valve preventing backflow of liquid from the brine container to or through the water supply path when the liquid is above the level of the entrance port so that brine displaced by solid salt added to the brine container is able to flow out of the brine container via the filling orifice in preference to the water supply path.

2. The washing appliance as claimed in claim 1, wherein the valve opens and closes the entrance port to control the level of liquid in the brine container to a nominal maximum level that is above a lowest height of the water supply path.

3. The washing appliance as claimed in claim 1, further comprising a primary water supply path for providing washing and/or rinsing water to the washing appliance, wherein the water supply path to the brine container has a first end at the entrance port to the brine container and a second end at an opening in a washing tub of the washing appliance, and wherein liquid is bled-off or leaks from the primary water supply path to at least partially fill the water supply path, the water within the water supply path flowing under gravity to the brine container when the valve is open but only when the water level in the water supply path is filled to above the height of the entrance port.

4. The washing appliance as claimed in claim 3, wherein the entrance port is displaced vertically above the opening in the washing tub.

5. The washing appliance as claimed in claim 1, wherein the height of the entrance port is at or above the lowest height of the filling orifice.

6. The washing appliance as claimed in claim 1, wherein the valve is a float valve having a float which rises and falls with the liquid level in the brine container, and wherein the valve closes the brine container entrance port when the float is at an upper float position.

7. The washing appliance as claimed in claim 6, wherein the float is provided within a float chamber which shares brine with the brine container, the float chamber communicating, at or near an upper side thereof, with a vent passage to allow trapped air to escape from the float chamber.

8. The washing appliance as claimed in claim 6, wherein the water softener further comprises a resin compartment for containing the ion-exchange resin, the resin compartment fluidly connected to the brine container by a filter for constraining solid salt to an upper part of the brine container, and wherein the float is positioned within the upper part of the brine container.

9. The washing appliance as claimed in claim 8, wherein the float is housed in, and able to move at least vertically within, a float chamber which is positioned in the upper region of the brine container, the float chamber having a plurality of openings therein that are shaped to allow brine to pass therethrough but to block solid salt crystals.

10. The washing appliance as claimed in claim 8, wherein a brine pump is located in a lower part of the brine container, the brine pump for supplying brine for regenerating the ion-exchange resin.

11. The washing appliance as claimed in claim 1, wherein the water supply path is substantially “U”-shaped.

12. The washing appliance as claimed in claim 11, wherein the substantially “U”-shaped water supply path has a substantially horizontal duct connecting lower ends of substantially parallel, substantially vertical side ducts.

13. The washing appliance as claimed in claim 12, wherein an upper end of a first side duct of the water supply path opens into the brine container and an upper end of a second side duct of the water supply path is connected to an opening in a washing tub of the appliance, the second side duct being fed with a supply of water at a position between its upper and lower ends, for example about mid-way between the upper and lower ends.

14. The washing appliance as claimed in claim 1, which is a dishwasher.

15. The washing appliance as claimed in claim 1, which is a drawer-type dishwasher or a drop-door-type dishwasher, and wherein the water softener and brine generator are provided in the front wall of a drawer of the drawer-type dishwasher or in the door of the drop-door-type dishwasher.

16. The washing appliance as claimed in claim 14, which is a drawer-type dishwasher.

17. The washing appliance as claimed in claim 2, further comprising a primary water supply path for providing washing and/or rinsing water to the washing appliance, wherein the water supply path to the brine container has a first end at the entrance port to the brine container and a second end at an opening in a washing tub of the washing appliance, and wherein liquid is bled-off or leaks from the primary water supply path to at least partially fill the water supply path, the water within the water supply path flowing under gravity to the brine container when the valve is open but only when the water level in the water supply path is filled to above the height of the entrance port.

18. The washing appliance as claimed in claim 2, wherein the height of the entrance port is at or above the lowest height of the filling orifice.

19. The washing appliance as claimed in claim 2, wherein the valve is a float valve having a float which rises and falls with the liquid level in the brine container, and wherein the valve closes the brine container entrance port when the float is at an upper float position.

20. The washing appliance as claimed in claim 7, wherein the water softener further comprises a resin compartment for containing the ion-exchange resin, the resin compartment fluidly connected to the brine container by a filter for constraining solid salt to an upper part of the brine container, and wherein the float is positioned within the upper part of the brine container.
